(19) United States
(12) Patent Application Publication
(10) Pub. No.: US 2005/0176470 A1
(43) Pub. Date: Aug. 11, 2005

(54) Display device

(75) Inventor: Toshitaka Yamakawa, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd, Kadoma-shi, Osaka (JP)

(21) Appl. No.: 10/516,276

(22) PCT Filed: Feb. 6, 2004
(86) PCT No.: PCT/JP04/01256

(51) Int. Cl. H04M 1/00; H04B 1/38

(52) U.S. Cl. 455/566; 455/575.1

(57) ABSTRACT

A problem to be solved by the invention is to provide a small-sized display device in which image data with a large information amount, such as moving images, large capacity mail data, and the like are displayable on a large-sized screen.

A mobile telephone (1) equipped with a display device includes an accommodating unit (5) arranged on one side of a main unit (2), and this accommodating unit (5) is provided with a winding/unreeling shaft (7) and can accommodate a display unit (4) including a polymer liquid crystal film or the like that can be wound up in a rolled-state by the winding/unreeling shaft (7). The display unit (4) is unreelable by reeling it out or pulling it out to protrude from an opening (6) of the accommodating unit (5). The display control unit (12) performs drive control of the winding/unreeling shaft (7) so that the display screen results in a size that corresponds to the display size of the display information by controlling an unreeling amount of the display unit (4), to allow the display unit (4) to display information. It is also possible to change the display size of the display information in performing display according to the unreeling amount of the display unit (4).

### TECHNICAL FIELD

The present invention relates to display devices for use with small-sized electronic apparatus such as mobile telephones.

### BACKGROUND ART

In recent years, mobile telephones have been developed to have an increasing number of functions and improved in their performance due to advancement of semiconductor technology and development of information infrastructures, and their prevalence in the market has been remarkable. Recently, in addition to the fundamental telephone function, they have become capable of performing the transmission and receipt of, for example, text mails, data of incoming call sounds and melodies, image data, moving image data, and large capacity mails containing image data, and further, two-way communication of moving images. In addition, they have become capable of acquiring and displaying various information through connecting networks.

Such mobile telephones are required to have smaller device sizes as a result of their portability being considered important, and also, for their display devices such as liquid crystal displays, small-sized ones are used. For uses in the telephone function, which is fundamental to the mobile telephone, a small-sized display device is sufficient; however, a large-sized display device is desired when, for example, displaying still images and moving images, displaying a large capacity mail, and displaying various information provided on the network. Nevertheless, if a large-sized display device is provided for a mobile telephone, the carrying thereof becomes difficult, causing inconvenience; moreover, because of the large-sized display device, limitations are imposed on the layout of its operating unit, and there is a risk that its operability may be sacrificed.

Conventionally, as an example of a display device that allows data or message with a large information amount to be displayed while maintaining a small size, a device has been proposed in which a lid unit that can be freely opened/closed is provided so as to oppose a display device provided for an apparatus main unit and another display device is deposed on a back face of the lid unit, whereby a multi-screen is formed when opening the lid unit (for example, see Patent Reference 1). Thus, conventionally, a method has been adopted in which a folding structure or a sliding structure is used to arrange a display unit with a liquid crystal display element or the like in order to widen a display area and accommodate the display in a compact way.

(Patent Reference 1) JP-A-9-247250 (pp. 2-3, FIG. 1)

As described above, when displaying various information with a large-sized display device in small-sized electronic apparatus such as mobile telephones, there have been problems that an apparatus housing becomes large in size, causing inconvenience in carrying, that the layout of the operating unit becomes difficult, and that its operability worsens.

In addition, in the above-described conventional display device, the display device of the device main unit and the display device provided on the back face of the lid unit are disposed independently of each other; therefore, when the lid unit is opened, the screen on which images are displayed becomes discontinuous, which may sometimes cause difficulty in viewing by users, and in particular, that is a problem that unnaturalness is caused when images are displayed.

Moreover, the conventional device has a problem that the information amount that can be displayed is limited because the size of the display screen in a display device cannot be changed according to the display size of display information.

The present invention has been accomplished in view of the foregoing circumstances, and its object is to provide a display device that does not degrade the operability of an apparatus in which the display device is incorporated, that can display image data with a large information amount such as moving images, large capacity mail data, and the like on a large-sized screen, and can reduce the size while in a non-display mode so that the carrying thereof becomes easy.

### DISCLOSURE OF THE INVENTION

A display device of the present invention is a display device having a display screen with a two-dimensional flat surface shape, comprising: a display unit configured to include a flat panel-shaped member that forms the display screen and has flexibility; a winding/unreeling shaft unit connected to one end of the display unit so as to wind up the display unit; an accommodating unit for accommodating the display unit wound up by the winding/unreeling shaft unit; an unreeling amount-detecting unit for detecting an unreeling amount of the display unit that has been unreeled protruding from the accommodating unit; and a display control unit for controlling the display unit according to the unreeling amount of the display unit and a display size of display information to be displayed on the display unit.

According to the foregoing configuration, the display unit is unreeled and allowed to protrude; thereby, even image data having a large information amount such as moving images, large capacity mail data, and the like can be displayed on a large-sized screen, and a small-sized, easy-to-carry display device can be realized by winding up the display unit by the winding/unreeling shaft unit and accommodating the display unit in the accommodating unit while in a non-display mode.

Further, the above-described display device may include a display control unit that adjusts the unreeling amount of the display unit by performing drive control of the winding/unreeling shaft unit according to the display size of the display information.

According to the foregoing configuration, the display control unit performs drive control of the unreeling amount of the display unit so that the unreeling amount can be changed according to the display size of the display information; therefore, even a data having a large information amount can be displayed appropriately according to the information amount on the display screen.

Further, the display device may include a display control unit that adjusts the display size of the display information according to the unreeling amount of the display unit detected by the unreeling amount-detecting unit, and sends out the display size to the display unit.

According to the foregoing configuration, the display size of the display information can be adjusted according to the unreeling amount of the display unit in displaying, and therefore, it becomes possible to display even a data with a large information amount on the screen appropriately according to the unreeling amount of the display unit.

Further, the display device may include a display control unit that performs information display in the display unit when the display unit is in such a state that the display unit is unreeled protruding from the accommodating unit, and stops information display in the display unit when the display unit is in such a state that the display unit is accommodated in the accommodating unit.

According to the foregoing configuration, a data with a large information amount can be displayed on a large-sized screen by unreeling the display unit only when necessary, both increasing of the display screen and size reduction of the device can be achieved, and further, it is possible to improve the operability and portability.

Further, the display device may include a display control unit that performs drive control of the winding/unreeling shaft unit to accommodate the display unit into the accommodating unit when a predetermined accommodating condition that has been determined in advance is satisfied.

According to the foregoing configuration, the display unit can be accommodated automatically and put it in a non-display mode when a predetermined accommodating condition is satisfied, for example, when an operation input is absent for a predetermined time or immediately before the battery runs out; and thus, usability can be improved.

The present invention also includes an electronic apparatus comprising any of the foregoing display devices. According to this configuration, by incorporating the display device in, for example, a small-sized electronic apparatus such as a mobile telephone, image data with a large information amount such as moving images, large capacity mail data, and the like can be displayed on a large-sized screen, and in addition, a small-sized, easy-to-carry electronic apparatus can be obtained.

In addition, by disposing an end portion of the display unit that is on the protruding side at the opening of the accommodating unit, it becomes possible to unreel the display unit to display necessary information by a simple operation, for example, by holding it with the hand and pulling it out, while the electronic apparatus in which the display device is incorporated is placed on a desk.

### BRIEF DESCRIPTION OF THE DRAWINGS

FIG. 1 is a view illustrating an outer appearance design of a mobile telephone for explaining an embodiment of the present invention;

FIG. 2 is a view showing the internal configuration of a mobile telephone that incorporates a display device of the present embodiment with a partially cutaway view;

FIG. 3 is a cross-sectional view taken along the line A-A′ in FIG. 2;

FIG. 4 is a view illustrating a functional configuration in a mobile telephone of the present embodiment;

FIG. 5 is a chart showing the flow of an operation procedure in the case where a display unit is taken out of a main unit and automatically unreeled to perform information display;

FIG. 6 is a view showing one example of unreeling amounts of a display unit that correspond to display sizes of display information;

FIG. 7 is a view showing the flow of an operation procedure in the case where a user draws out and unreels a display unit from the main unit arbitrarily to perform information display;

FIG. 8 is a view showing one example of display sizes of display information that are variable corresponding to unreeling amounts of the display unit; and

FIG. 9 is a view showing the flow of an operation procedure in the case where the display unit protruding from the main unit is accommodated in an accommodating unit of the main unit.

In the drawings, reference numeral 1 denotes a mobile telephone, reference numeral 2 denotes a main unit, reference numeral 3 denotes an operation unit, reference numeral 4 denotes a display unit, reference numeral 5 denotes an accommodating unit, reference numeral 6 denotes an opening, reference numeral 7 denotes a winding/unreeling shaft, reference numeral 8 denotes an unreeling amount-detecting unit, reference numeral 9 denotes an end portion, reference numeral 10 denotes a control unit, reference numeral 11 is a memory, and reference numeral 12 is a display control unit.

### BEST MODE FOR CARRYING OUT THE INVENTION

The present embodiment illustrates an example of a configuration in which a display device is applied to a mobile telephone, taking a mobile telephone as an example of the small-sized electronic apparatus.

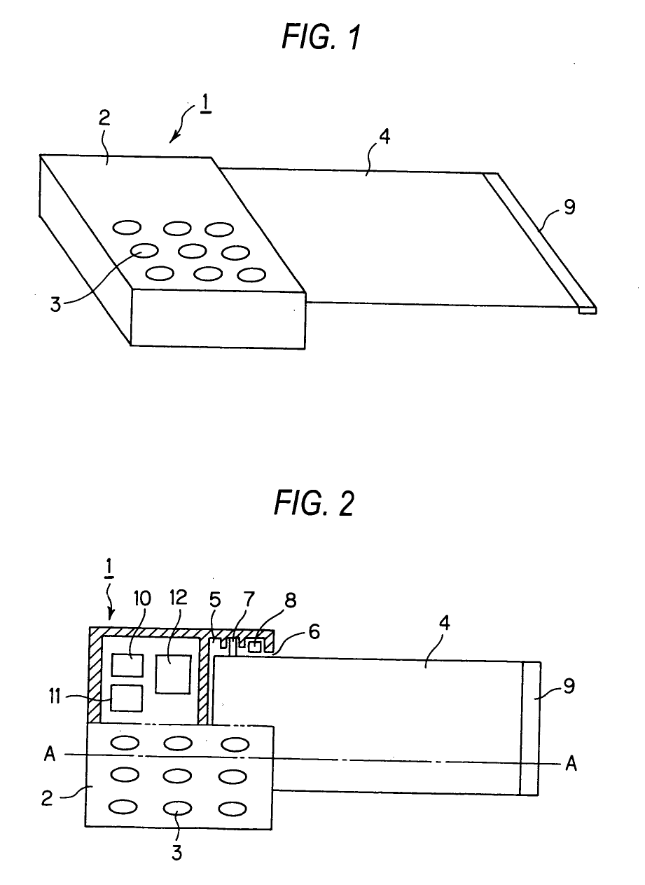

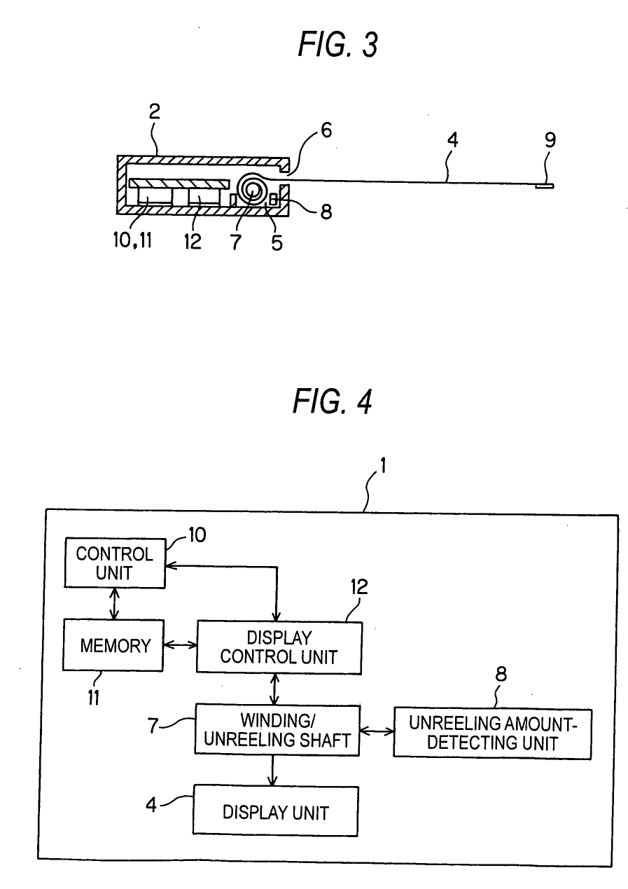

FIG. 1 is a view illustrating the outer appearance design of a mobile telephone for explaining an embodiment of the present invention. FIG. 2 is a view showing the internal configuration of a mobile telephone that incorporates a display device of the present embodiment with a partially cutaway view, and FIG. 3 is a cross-sectional view taken along the line A-A′ in FIG. 2.

A mobile telephone 1 of the present embodiment comprises a main unit 2, an operation unit 3 provided on the main unit 2, and a display unit 4 provided so as to be accommodatable and unreelable with respect to the main unit 2. The main unit 2 includes a housing formed into a thin, substantially rectangular parallel-piped box shape. The operation unit 3 includes operation keys disposed on the surface of the main unit 2, such as number pads and function keys. The display unit 4 comprises a member that has a substantially rectangular-shaped, thin, flat panel-shape and has flexibility, which forms a display screen with a two-dimensional flat surface shape; the display unit is configured so as to be accommodated inside the main unit 2 in a wound-up state while in a non-display mode and to be unreelable either by a driving means or manually, while in a display mode. In addition, the interior of the main unit 2 is provided with circuit components that attain the functions of a control unit 10, a memory 11, a display control unit 12, and the like, which are mounted on a substrate.

An accommodating unit 5 that can accommodate the display unit 4 is provided in one of the side portions of the main unit 2, and a long, narrow opening 6 is formed to have an opening in the side face portion of the main unit 2 where this accommodating unit 5 is provided. The display unit 4 comprises a polymer liquid crystal film or the like, and is wound up in a rolled-state in the longitudinal direction so that it is accommodated in the accommodating unit 5. This display unit 4 is configured so that when it is unreeled, one end portion thereof protrudes from the opening 6 and is extendable in a flat panel shape. The one end portion of the display unit 4 that is on the protruding side is formed with a thick-wall end portion 9 that serves as a grip portion to be held by the hand when the display unit 4 is manually pulled out.

In the accommodating unit 5, a winding/unreeling shaft 7, to which the other end portion of the display unit 4 that is on the accommodating side is firmly fixed, is rotatably provided for winding up and accommodating the display unit 4. This winding/unreeling shaft 7 is provided with a signal line, which is not shown in the figure, for electrically connecting the display unit 4 and the display control unit 12, and a drive mechanism, which is not shown in the figure, for spreading out and unreeling the display unit 4 from the opening 6 to the outside of the main unit 2 and winding up the unreeled display unit 4 back into the accommodating unit 5. It should be noted that the winding/unreeling shaft 7 is set free by turning the drive mechanism through the control of the display control unit 12, and under this condition, the user can pick up the end portion 9 of the display unit 4 and unreel the display unit by pulling it out from the opening 6.

Further, the accommodating unit 5 is furnished with an unreeling amount-detecting unit 8 for detecting an unreeling amount of the display unit 4 when it is spread out, or is unreeled by pulling it out, from the opening 6, that is, the size of the display unit 4 that protrudes outside.

FIG. 4 is a view illustrating a functional configuration in a mobile telephone of the present embodiment. The control unit 10 is for controlling, for example, the operation of the mobile telephone 1 as a whole, and mainly comprises a processor. The display control unit 12 is for performing control operations regarding the display unit 4, such as information display and driving. The memory 11 is for storing an operation program for the control unit 10, various data related to device operations or the like, display data of images and characters that are displayed on the display unit 4, and so forth, and comprises RAM, ROM, or the like. The control unit 10, the memory 11, and the display control unit 12 are connected to each other.

The display control unit 12 is connected to the unreeling amount-detecting unit 8 and the display unit 4 via the winding/unreeling shaft 7. The unreeling amount-detecting unit .8 comprises a photosensor or the like; it detects the size of the display unit 4 that protrudes outside by detecting a wind-up amount of the display unit 4 inside the accommodating unit 5, a calibration marking provided on a side end portion of the display unit 4, and the like, and outputs a detection signal to the display control unit 12. The winding/unreeling shaft 7 rotates according to the control from the display control unit 12 so as to perform spreading-out and winding-up of the display unit 4. The display control unit 12 outputs a display signal to the display unit 4 based on the display information from the control unit 10, and performs drive control of the winding/unreeling shaft 7 according to the control information from the control unit 10 and the detection signal from the unreeling amount-detecting unit 8.

The display unit 4 performs information display of characters, images and the like on the display screen according to the display signal from the display control unit 12. At this time, for example, the display control unit 12 outputs a display signal to perform information display when the display unit 4 is spread out or drawn out so that it protrudes outside the main unit 2, and stops the outputting of the display signal to finish the information display when the display unit 4 is wound up by the winding/unreeling shaft 7 and accommodated in the accommodating unit 5.

Next, the operations in the display device of the present embodiment are described.

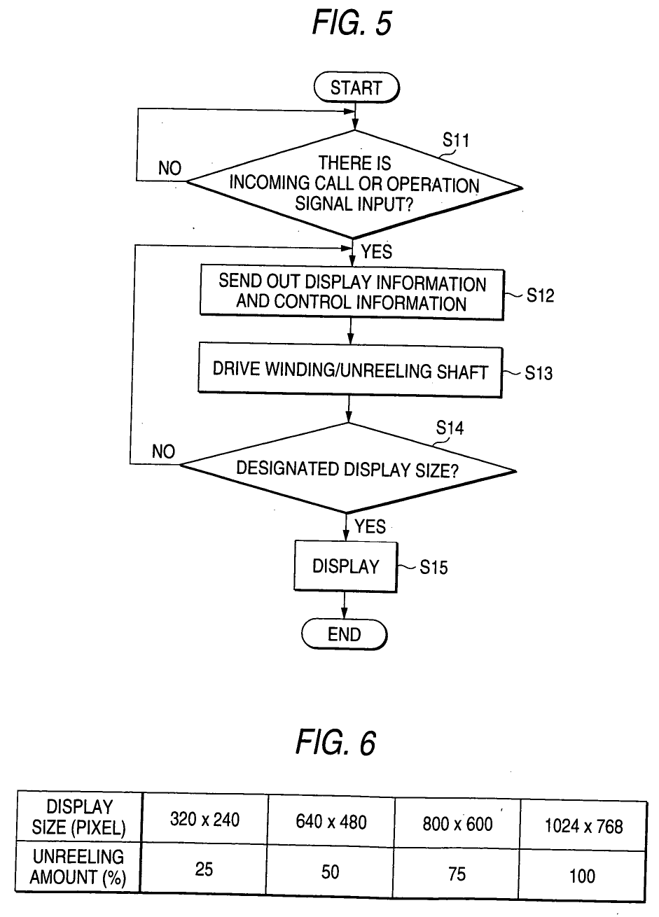

FIG. 5 is a chart showing the flow of an operation procedure in the case where the display unit 4 is automatically spread out and unreeled from the main unit 2 to perform information display.

In this case, first, the control unit 10 monitors whether or not the mobile telephone 1 has an incoming call such as a video telephone, or whether or not there is an operation signal input from the operation unit 3 for displaying an image (step S11). Here, if there is an incoming call or an operation signal input, the control unit 10 sends out, to the display control unit 12, display information for image data to be displayed and control information for adjusting an unreeling size of the display unit 4 to be the display size of that display information (step S12). If an image data that has been pre-stored in the mobile telephone 1 is to be displayed, the control unit 10 reads out the image data from the memory 11 and transfers the data to the display control unit 12 as display information.

The display control unit 12 receives the control information from the control unit 10 and sends out a drive signal to the winding/unreeling shaft 7 in order to drive a drive mechanism (not shown in the figure) for the winding/unreeling shaft 7 (step S13). Thus, the display unit 4 is spread out and unreeled from the opening 6 of the main unit 2. At this time, the unreeling amount of the display unit 4, that is, the area of the display screen of the display unit 4 that has protruded outside is detected by the unreeling amount-detecting unit 8, and the unreeling amount is fed back to the display control unit 12 as a detection signal. The display control unit 12 determines whether or not the unreeling amount of the display unit 4 is a designated size that corresponds to the display size of the display information (step S14).

Here, the corresponding relationship between the display size of the display information and the unreeling amount of the display unit 4 will be explained. FIG. 6 is a view illustrating one example of unreeling amounts of the display unit 4 that correspond to display sizes of display information. In this FIG. 6, unreeling amounts are shown assuming that when the maximum size of display information that can be displayed with the mobile telephone 1 is 1024×768 pixels, the unreeling amount in the case where the entirety of the display unit 4 is spread out from the main unit 2 for displaying is 100%. Accordingly, when the display size is 1024×768 pixels, the unreeling amount is set to be 100%; when the display size is 800×600 pixels, the unreeling amount is set to be 75%; when the display size is 640×480 pixels, the unreeling amount is set to be 50%; and when the display size is 320×240 pixels, the unreeling amount is set to be 25%.

If the unreeling amount of the display unit 4 is determined as a designated size corresponding to the display size of the display information in step S14 of FIG. 5, the process proceeds to step S15, and the display control unit 12 sends out a display signal based on the display information of image data to the display unit 4. Thus, the display information is displayed on the display unit 4 with the designated display size. On the other hand, if the unreeling amount of the display unit 4 is less than the designated size in step S14, the process returns to step S12, and the control operation for spreading out the display unit 4 is repeated until the unreeling amount corresponding to the display size is reached.

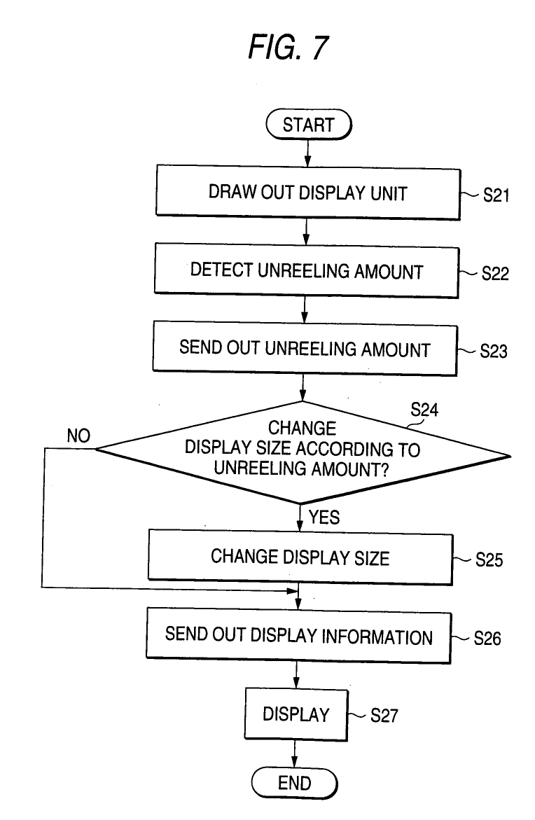

FIG. 7 is a view showing the flow of an operation procedure in the case where a user draws out and unreels a display unit from the main unit arbitrarily to perform information display.

In this case, if the end portion 9 of the display unit 4 is held with the fingers by a user and drawn out from the opening 6 (step S21), the unreeling amount-detecting unit 8 detects the unreeling amount of the display unit 4 that has been pulled out (step S22) and sends it out as unreeling amount data to the display control unit 12 (step S23). Thus, the display control unit 12 acquires a current unreeling amount of the display unit 4.

Next, the control unit 10 receives the unreeling amount data from the display control unit 12 and judges whether or not the display size of the display information should be changed (step S24), and if the unreeling amount and the display size do not correspond to each other, it changes the display size of the display information (step S25).

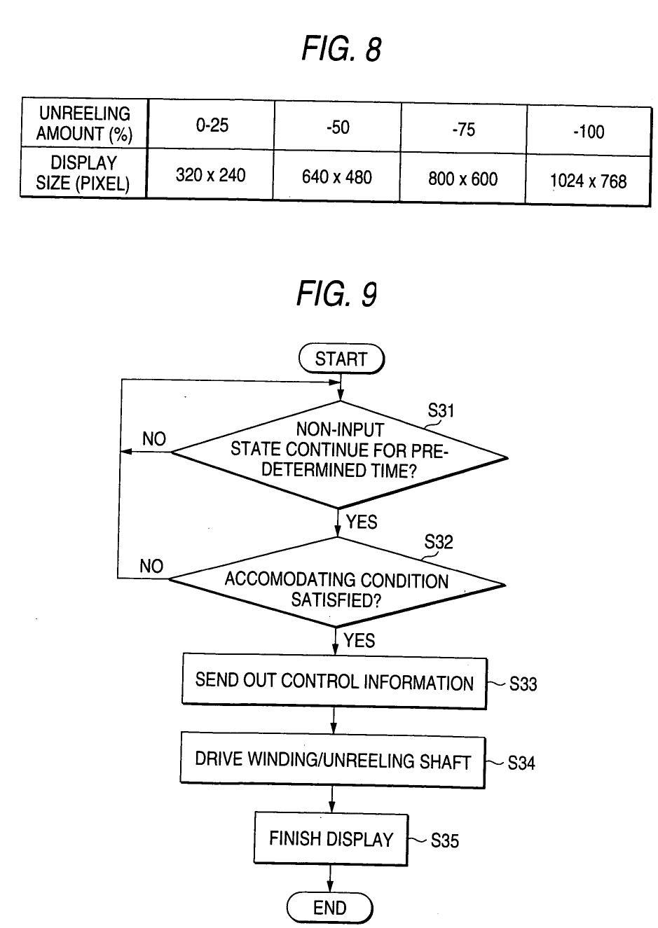

Here, the corresponding relationship between unreeling amounts of the display unit 4 and display sizes of display information to be changed will be explained. FIG. 8 is a view showing one example of display sizes of display information that are variable corresponding to unreeling amounts of the display unit. This FIG. 8 shows: when the unreeling amount is 75 to 100%, the display size can be changed into 1024×768 pixel; when the unreeling amount is 50 to 75%, the display size can be changed into 800×600 pixels; when the unreeling amount is 25 to 50%, the display size can be changed 640×480 pixels; when the unreeling amount is less than 25%, it can be changed into 320×240 pixels.

Next, the control unit 10 sends out display information for image data to the display control unit 12 (step S26). It should be noted that when the display size is not changed at step S24, the display size changing step of the step S25 is not performed and the display information is sent out in step S26. Then, the display control unit 12 sends out a display signal based on the display information of the display unit 4. Thus, the display information is displayed with a designated display size on the display unit 4 (step S27).

FIG. 9 is a view showing the flow of an operation procedure in the case of accommodating the display unit 4 that has protruded from the main unit by being spread out automatically or being drawn out is accommodated in an accommodating unit 5 of the main unit 2.

In this case, first, the control unit 10 monitors whether or not a non-input state is kept in the mobile telephone 1 for a certain period of time (step S31). If the non-input state continues, it confirms whether or not such a predetermined accommodating condition for the display unit 4 to be accommodated is satisfied, for example, such accommodating conditions as there is no key operation for a certain period of time, or as it is just before the remaining amount of battery expires (step S32). It should be noted that here, the control unit 10 may monitor whether or not there is an operation signal input from the operation unit 3 for accommodating the display 4, and if there is an operation signal input for indicating an accommodating operation, the control unit 10 may confirm whether or not the accommodating condition is satisfied.

If it is confirmed that whether or not the accommodating condition is satisfied, the control unit 10 sends out control information for accommodating the display unit 4 to the display control unit 12 (step S33). The display control unit 12 receives the control information from the control unit 10 and sends out a drive signal to a winding/unreeling shaft 7, and a drive mechanism (not shown in the figure) drives the winding/unreeling shaft 7 (step S34). Thus, the display unit 4 is wound up by the winding/unreeling shaft 7 and is accommodated into the accommodating unit 5 of the main unit 2. Then, the display control unit 12 stops the output of the display signal to the display unit 4, and finishes information display (step S35).

Thus, the display device of the present embodiment is configured as follows: an accommodating unit 5 is provided on a side end portion of a main unit 2 of a mobile telephone 1, and one end of a film-like display unit 4 comprising a polymer liquid crystal film or the like and having flexibility is attached to a winding/unreeling shaft 7 provided inside the accommodating unit 5; the display unit is accommodated by wrapping it around the winding/unreeling shaft 7 in a rolled-state; and it can be unreeled by reeling it out or drawing it out from an opening 6 of the main unit 2.

Then, the display unit 4 is spread out from the main unit 2 to protrude outward by controlling in such a manner that the unreeling amount corresponds to the display size of the display information; thus, display information is displayed. Alternatively, when a user holds and pulls out an end portion 9 of the display unit 4, the display size is changed so as to correspond to the unreeling amount of the display unit 4; and thus, display information is displayed.

According to such a configuration, it is made possible to realize a small-sized display device in which image data with a large information amount such as moving images, a large capacity mail data, and the like can be displayed on a large-sized screen without degrading the operability of the apparatus that incorporates the display device and without causing unnaturalness even if it is incorporated in an electronic apparatus such as a mobile telephone, which has had a problem of balancing the conflicting demands for size reduction and for information display with a large-sized screen, and moreover, the carrying is easy while in a non-display mode.

It should be understood that although the above-described embodiment has described an example in which the main unit 2 of the mobile telephone 1 is made into a box having a substantially rectangular parallel-piped shape, the present invention can be applied similarly to other shapes as long as a display unit 4 having flexibility can be wound up and accommodated in a rolled-state, and can be unreeled in a flat panel shape.

Furthermore, although the foregoing has described an example in which the display unit 4, the accommodating unit 5, the opening 6, the winding/unreeling shaft 7, and so forth are arranged on one side of the main unit 2 along its longitudinal direction, the invention can be embodied similarly even when they are arranged at other positions, such as in an end portion that has an opening toward other directions, for example, a shorter side direction of the main unit 2, the vertical direction with respect to the front face of the main unit 2, or the like.

Although the present invention has been described in detail with reference to specific preferred embodiments thereof, it will be apparent to those skilled in the art that various changes and modifications may be made herein without departing from the scope and sprit of the present invention.

The present application is based on Japanese Patent Application No. 2003-075860, filed on Mar. 19, 2003, the content of which is incorporated by reference herein.

### INDUSTRIAL APPLICABILITY

As has been described above, the present invention makes it possible to provide a display device that does not degrade the operability of the apparatus in which the display device is incorporated, that can display image data with a large information amount such as moving images, large capacity mail data, and the like with a large-sized screen, and can reduce its size while in a non-display mode so that carrying becomes easy.

1. A display device having a display screen with a two-dimensional flat surface shape, comprising:
a display unit configured to include a flat panel-shaped member that forms the display screen and has flexibility;
a winding/unreeling shaft unit connected to one end of the display unit so as to wind up the display unit;
an accommodating unit for accommodating the display unit wound up by the winding/unreeling shaft unit;
an unreeling amount-detecting unit for detecting an unreeling amount of the display unit that has been unreeled protruding from the accommodating unit; and
a display control unit for controlling the display unit according to the unreeling amount of the display unit and a display size of display information to be displayed on the display unit.

2. The display device as set forth in claim 1, wherein the display control unit adjusts the unreeling amount of the display unit by performing drive control of the winding/unreeling shaft unit according to the display size of the display information.

3. The display device as set forth in claim 1, wherein the display control unit adjusts the display size of the display information according to the unreeling amount of the display unit detected by the unreeling amount-detecting unit, and sends out the display size to the display unit.

4. The display device as set forth in claim 1, wherein the display control unit performs information display in the display unit when the display unit is in such a state that the display unit is unreeled protruding from the accommodating unit, and stops information display in the display unit when the display unit is in such a state that the display unit is accommodated in the accommodating unit.

5. The display device as set forth in claim 1, wherein the display control unit performs drive control of the winding/unreeling shaft unit to accommodate the display unit into the accommodating unit when a predetermined accommodating condition that has been determined in advance is satisfied.

6. An electronic apparatus comprising a display device as set forth in any one of claims 1 through 6.
